(19) United States
(12) Patent Application Publication
(10) Pub. No.: US 2025/0015874 A1
(43) Pub. Date: Jan. 9, 2025

(54) MULTI-HOP PARALLEL RELAY BASED NETWORKING SYSTEM AND METHOD THEREOF

(71) Applicant: INDIAN INSTITUTE OF TECHNOLOGY KHARAGPUR, KHARAGPUR (IN)

(72) Inventors: Chittotosh GANGULY, Kharagpur (IN); Anupam SHOME, Kharagpur (IN); Amit Kumar DUTTA, Kharagpu (IN)

(73) Assignee: INDIAN INSTITUTE OF TECHNOLOGY KHARAGPUR, KHARAGPUR (IN)

(21) Appl. No.: 18/581,010

(22) Filed: Feb. 19, 2024

(30) Foreign Application Priority Data
Jul. 7, 2023 (IN) 202331045915

(51) Int. Cl. H04B 7/155; H04L 45/00; H04W 28/02

(52) U.S. Cl. CPC H04B 7/15507; H04L 45/20; H04W 28/0236

(57) ABSTRACT

The present invention relates to a multi-hop parallel relay structure in 5G-NR at RRC level connection establishment wherein a relay network is formed between source remote UE and destination UE or gNB. In a particular hop there may be multiple parallel relay devices working simultaneously, also an individual relay device may be connected to multiple devices to the next hop through different radio links. A fixed device in a particular hop may be connected to more than one device from preceding hop through separate radio links. An algorithm for selecting relay to configure multi hop parallel relay network based on SNR and RSRP has been proposed.

### CROSS REFERENCE TO RELATED APPLICATION

This application claims priority from Indian Patent Application No. 202331045915, filed Jul. 7, 2023, which is incorporated by reference in its entirety.

### FIELD OF THE INVENTION

The present invention is related to a multi-hop parallel relay for 5G-NR. More specifically, the present invention is directed to provide a multi-hop parallel relay-based networking system in 5G-NR at radio resource control (RRC) level connection wherein a relay network is formed between a source remote user equipment (UE) and a destination UE or next Generation NodeB (gNB) involving multiple parallel relay devices working simultaneously. A relay device in a particular hop may be connected to more than one relay device from a preceding hop through separate radio links. A method for selecting relay devices to configure multi hop parallel relay network based on Signal to Noise ratio (SNR) and Reference Signal Received Power (RSRP) has also been proposed.

### BACKGROUND OF THE INVENTION

Fifth generation new radio, or 5G-NR, is a recent development in cellular technology. In order to connect everyone and everything together, including machines, objects, and gadgets, 5G enables a new core and access network. The goal of 5G wireless technology is to provide more users with faster multi-Gbps peak data rates, extremely low latency, enhanced reliability, vast network capacity, and a more consistent user experience. New user experiences are facilitated through enhanced performance and efficiency, which further connects new industries. The motto of 5G NR is that everything is connected everywhere. However, it may happen due to fading that user equipment (UE) may be in outage. A UE may be outside of the coverage area of a gNB. In this context, relays will play a pivotal role in maintaining connectivity. Baruch Yosef Altman (Pub. No. WO2018/211488 A1) had developed a system and method of wireless multiple-link vehicular communication wherein the data is transferred through a relay to a remote node. Wi-Fi, i.e., unlicensed spectrum, has been used for communication between the relay and remote node. There is no provision for using licensed spectrum. Xueying Diao, Mengzhen Wang and Lin Chen (Pub. No. WO 2021/109382 A1) had developed Systems and methods for signaling transmission for side-link relay communications. In this patent, a method for signaling transmission has been proposed whereas the signaling transmission is performed by UE relay. The method steps are following: obtaining indication information from gNB which indicates that the wireless communication device supports a side-link relay communication. Second network node then transmits indication information that wireless communication device is authorized for relay communication. Richard Lee Chee Kuo (Pub. No. US 2021/0409263 A1) had proposed a method and apparatus for handling side-link radio link failure in a wireless communication system. In this patent, a side-link failure handling method for a User Equipment to User Equipment (UE to UE) relay has been proposed. Henry Chang, Masato Jishiro Kyocera Corporation had developed a relay device management with multiple quality threshold whereas selecting alternative relay link when SNR present link goes below certain threshold. Convida Wireless LLC had proposed. Lien et al. (3GPP NR Side-link Transmissions Toward 5G V2X, in IEEE Access, vol. 8, pp. 35368-35382, 2020, doi: 10.1109/ACCESS.2020.2973706) required knowledge of 3GPP NR side-link transmissions, comprising of resource allocation mechanisms, resource sensing and selection procedures, synchronization, and quality-of-service (QOS) management in provided in this paper. Zhang (Side-link Relay in NR and NR Advanced in 2021 IEEE/CIC International Conference on Communications in China (ICCC Workshops), 2021, pp. 358-362, doi: 10.1109/ICCCWorkshops52231.2021.9538896) Some important aspects of side-link relays for Rel-17 are discussed and remarks are made for enhancements of side-link relay for oriented for beyond 5G.

In summary, it is to be noted that the 5G-NR standard talks about only single-hop relays. Multi-hop or parallel relays are not part of the standard as of now. Therefore, a multi-hop parallel relay-based networking system for connecting a source remote UE with a destination UE or gNB can significantly improve the 5G-NR system.

### OBJECT OF THE INVENTION

It is thus the main object of the present invention is to develop a multi-hop parallel relay based networking system for connecting a source remote UE with a destination UE.

Another object of the present invention is to develop a multi-hop parallel relay based networking system for connecting a source remote UE with a gNB.

Another object of the present invention is to develop a method for selecting relay devices to configure multi hop parallel relay network based on Signal to Noise ratio (SNR).

Yet another object of the present invention is to develop a method for selecting relay devices to configure multi hop parallel relay network based on Signal to Noise ratio (SNR) and Reference Signal Received Power (RSRP)

### SUMMARY OF THE INVENTION

Thus according to basic aspect of the present invention there is provided a multi-hop parallel relay based networking system for connecting a source remote UE (user equipment) with a destination UE or gNB comprising
multiple parallel relay devices in multiple connected hops between the source remote UE and the destination UE or gNB;
Uu link for connecting the destination UE or gNB with last hop of the multiple connected hops;
PC-5 link for connecting the source remote UE with first hop of the multiple connected hops.

In a preferred embodiment of the present multi-hop parallel relay based networking system, the Uu link includes air interface between NR-UE (New Radio User equipment) and a gNB (next generation Node B)

In a preferred embodiment, the PC-5 link includes direct communication interface between a UE (user equipment) to another UE (user equipment)

In a preferred embodiment of the present multi-hop parallel relay based networking system, each of the hops includes one or more relay devices and each of the hops is connected to its neighboring hops through the said PC-5 links, whereby the relay devices in a particular hop are connected to one or more relay devices from preceding hop through separate radio links.

According to another aspect in the present invention there is provided a method of establishing RRC (radio resource control)-level connection and relay selection for multihop-parallel relay topology in 5G NR comprising the steps of arranging discovered relay devices according to RSRP and SNR;
searching and discovering of possible relay device;
checking of all relay devices for unique ID;
checking for number of the relay devices with unique ID, labelling them and checking whether all the said relay device received unique ID.

In the above method, arranging discovered relay devices according to RSRP and SNR comprises
checking the destination UE whether the said UE is in an outage or is a remote node;
connecting the UE to the corresponding gNB if the UE is not a remote node or not in the outage; searching for possible relay devices if the UE is remote or in an outage;
checking for any possible relay devices, if it is found, it will discover the possible relay device and if it is not found it will again search for possible relay devices;
arranging the said discovered relay devices according to RSRP and SNR in descending orders.

In the above method, searching and discovering of possible relay device comprises
connecting the maximum N_{D} devices through the PC-5 links;
assigning the relay chain ID and hop ID to N_{D} devices;
checking whether any of ND devices connected to gNB;
ending process if it is found connecting to gNB through RRC connection alternatively setting the hop count to 2 and checking the hop number whether the maximum allowed hop is exceeded or not;
whereby after finishing the search for gNB if the hop count is less than the maximum allowed hop count, then the relay devices at hop l discover relay devices for the hop (l+1) and the relay devices at lth hop will look for any available relay devices and if no such devices are available, again discovering for possible relay devices.

In the above method, checking of all relay devices for unique ID comprises
setting device ID to 1 for lth hop;
checking the number of devices at lth hop is less than the maximum allowed devices at each hop;
whereby if the number of devices is less than the maximum allowed device number ND, the device looks for possible relay devices for (l+1)^{th} hop including checking for any possible relay devices that are variable or not;
whereby if the relay devices are available, selecting the best relay device based on RSRP and SNR alternatively if any relay candidate in relay devices are unavailable incrementing the device counter and after incrementing the device counter, checking the number of the said relay devices at lth hop is less than the maximum allowed devices at each hop;
whereby if the number of the relay devices is greater than the allowed relay devices checking whether all the relay devices are connected for (l+1)^{th} hop including checking for the relay devices with unique device ID;
whereby if all the device IDs are unique and the number of devices is less than the maximum number of allowed devices for a hop, i.e., N_{D} increasing the hop count by one and again checking the hop number Whether the maximum allowed hop is exceeded or not.

In the above method, checking for number of relay devices with unique ID, labelling them and checking whether all the said relay device received unique ID comprises
looking for devices with unique IDs, if all the device IDs are not unique;
labeling the relay devices connected through PC-5 links;
looking for the remaining unique devices and arranging the remaining discovered devices in descending order;
labeling all the devices appropriately. and checking for all connected devices are unique or not;
looking for the remaining unique devices, if all devices are not unique and incrementing the hop count by one and return to the step wherein checking the hop number, whether the maximum allowed hop is exceeded or not if all devices are unique.

### BRIEF DESCRIPTION OF THE ACCOMPANYING DRAWINGS

FIG. 1 shows multihop-parallel relay between a remote UE and gNB.

FIG. 2 shows multi-hop-parallel relay between a remote UE and a destination UE.

FIG. 3 shows establishment of a relay network between a remote UE and a gNB.

FIG. 4 shows establishment of a relay network between a remote UE and a destination UE.

FIG. 5A shows steps for multihop-parallel relay network establishment between a remote UE and gNB-part A

FIG. 5B shows steps for multihop-parallel relay network establishment between a remote UE and gNB-part B

FIG. 5C shows steps for multihop-parallel relay network establishment between a remote UE and gNB-part C

FIG. 5D shows steps for multihop-parallel relay network establishment between a remote UE and gNB-part D

FIG. 6A shows steps for multihop-parallel relay network establishment between a remote UE and a destination UE-part A

FIG. 6B shows steps for multihop-parallel relay network establishment between a remote UE and a destination UE-part B

FIG. 6C shows steps for multihop-parallel relay network establishment between a remote UE and a destination UE-part C

FIG. 6D shows steps for multihop-parallel relay network establishment between a remote UE and a destination UE-part D

FIG. 7 shows proposed L2 U2N remote UE connection establishment procedure for parallel relay scenario.

FIG. 8 shows proposed L2 U2N remote UE connection establishment procedure for multihop-parallel relay scenario.

FIG. 9 shows proposed relay ranking algorithm

FIG. 10 shows SER vs transmit power of UE-s, P (dBm)

FIG. 11 shows SER vs NO

FIG. 12 shows the relationship between overall throughput (T_{d}) of the parallel-multi-hop relay communication system and transmitted power of a UE, i.e., P for different number of relays.

### DETAILED DESCRIPTION OF THE PREFERRED EMBODIMENTS WITH THE ACCOMPANYING DRAWINGS

In this invention A remote UE may find a gNB or the destination UE through L hops (typically L≥1). At l^{th} hop, maximum N_{D} number of relay devices has been proposed to limit the connection to The i^{th} device at the l^{th} hop may be connected to the multiple devices at (l+1)^{th} hop through different radio links. Similarly, multiple devices of (l−1)^{th} hop may be connected to the i^{th} device at lth hop through separate radio links. At every layer, it checks whether the destination UE or gNB has been reached or not. If reached, the network terminates there. If a remote UE is in outage due to fading or outside of the coverage area of a gNB, it looks for possible candidate relay devices. The remote UE discovers possible relay devices in the vicinity. The discovered relay devices are ranked according to the signal to noise ratio (SNR) and reference signal received power (RSRP). At the first hop (l=1), the remote UE selects a maximum of ND devices according to the descending order and establishes PC-5 connections with them. A relay chain ID has also been provided to all selected relay devices. The relay devices at the l^{th} hop look for destination UE or gNB; if found, the network terminates there. Otherwise, the relay devices at l^{th} hop look for the next set of relay candidates. Each relay device at l^{th} hop connects with at least one relay device at the (l+1)^{th} hop if available. There will be a check for relay devices' ID at the (l+1)^{th} hop. If all the devices are unique, proceed to the next hop. However, if devices are not unique, discover leftover relay candidates at (l+1)^{th} hop and connect them according to the descending order of SNR and RSRP. Repeat this process until ND unique relay devices are available at (l+1)^{th} hop. The relay network selection procedure is continued till l=L hop. If the destination UE or gNB is not found till then, the network terminates.

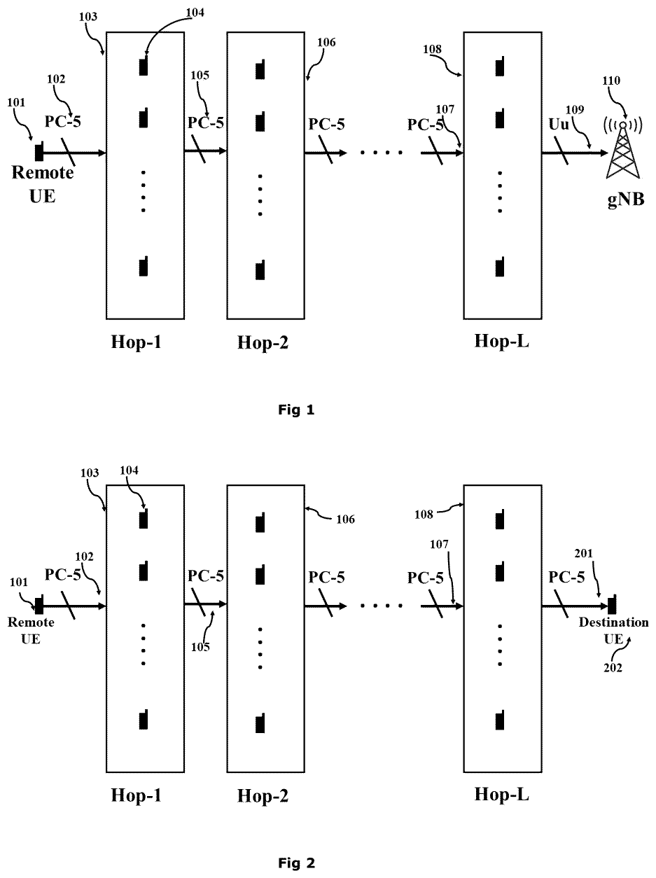

A schematic diagram of the proposed scheme is depicted in FIG. 1 and FIG. 2. In FIG. 1 a remote UE, 101 is connected to the gNB, 110, through L hops. The connection between L^{th} hop and gNB is through Uu link, 109. 101 is connected to 1^{st} hop, 103, through PC-5 link, 102. A hop, 103 may contain many relay devices like 104. 1^{st} hop, 103 is connected to 2^{nd} hop, 106 through PC-5 links 105. Similarly, L^{th} hop, 108 also receives PC-5 links, 107 from previous hop.

In FIG. 2, a multihop-parallel network is suggested between a remote UE, 101 and a destination UE, 202. The destination UE, 202 is connected to L^{th} hop, 108 through PC-5 links, 201.

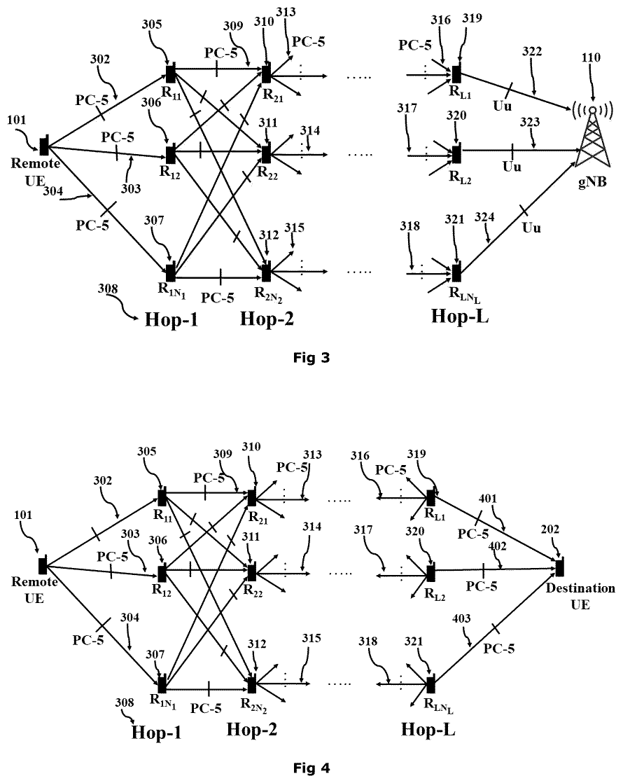

A detailed diagram of the proposed scheme is depicted in FIG. 3 and FIG. 4. In FIG. 3 a remote UE, 101 is connected to the gNB, 110, through L hops. The connection between L^{th} hop UEs such as 319,320, and 321 and gNB, 110 is through Uu link, 322, 323, and 324. 101 is connected to 1^{st} hop, UEs such as 305, 306, and 307 through PC-5 links, 302, 303, and 304. A relay device R11 of 1st hop, is connected to a relay device R21 through PC-5 link 309. Similarly, at L^{th} hop, relay devices 319, 320, 1^{nd} 321 also receive PC-5 links, through 316, 317, and 318 from previous hop.

In FIG. 4 a multihop-parallel network is suggested between a remote UE, 101 and a destination UE, 202. The destination UE, 202 is connected to Lth hop relay devices 319, 320, and 321 through PC-5 links 401, 402, and 403.

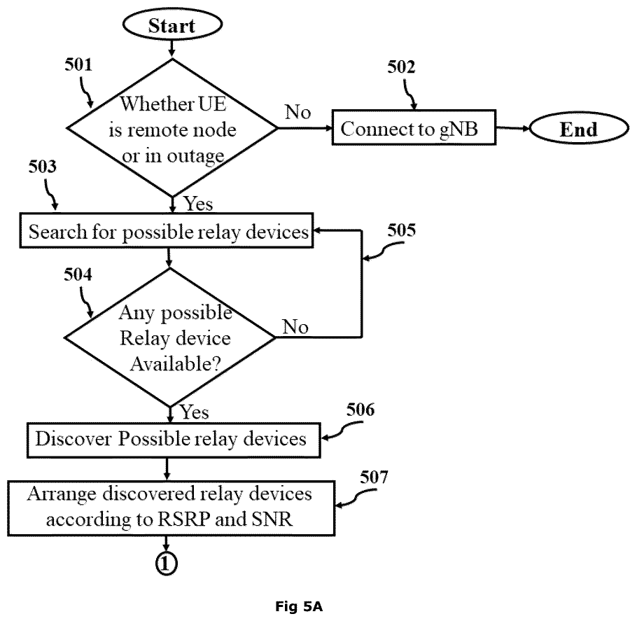

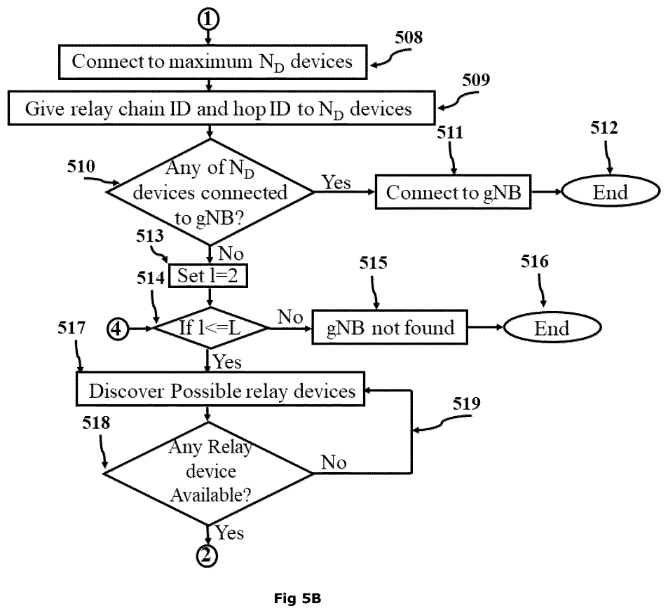

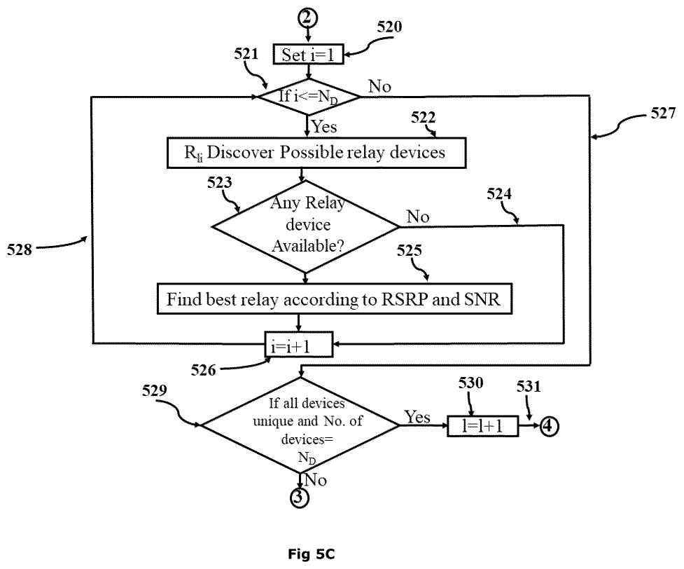

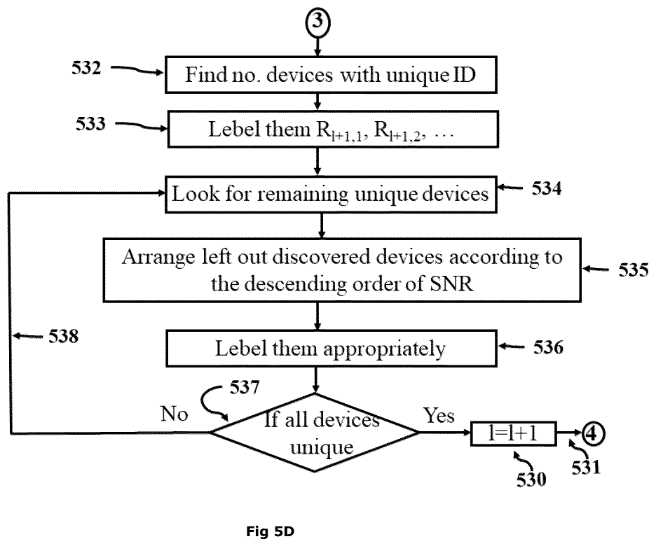

FIG. 5 (5A, 5B, 5C, 5D) shows the steps for establishing a multihop-parallel relay network between a remote UE and gNB. The network consists of a maximum of L hops; for each hop, there may be a maximum of ND user equipment (UE) devices. The details of the steps are as follows:

At step 501 it has been checked whether the UE is in an outage or is a remote node. If the UE is not a remote node or not in the outage, it will be connected to the corresponding gNB at step 502, and the process ends there. However, if the UE is remote or in an outage, it will search for possible relay devices at step 503. At step 504, the remote UE checks whether any possible relay devices are available in the vicinity. If no such devices are available at step 505, it will go to step 503. If possible, relay devices are available at step 506; remote UE discovers possible relay candidates using the Prose discovery process. The discovered relay UEs are arranged according to the RSRP and SNR in descending order at step 507. The remote UE will connect the best N_{D} devices through the PC-5 links at step 508. Relay-chain ID and hop Id to the connected N_{D} devices for identifying the relay chain are assigned in step 509. Any of the N_{D} devices connected to the gNB is checked at step 510. If any devices are connected to the gNB through the Uu link, then remote UE will make an RRC connection through that device at step 511.

The procedure ends there at step 512. If no device is connected to gNB, set the hop count to 2 at step 513. Whether the maximum allowed hop is exceeded or not is taken care of by step 514. If the hop number exceeds the maximum allowed hops, the search for gNB ends at step 515. The procedure ends at step 516. If the hop count is less than the maximum allowed hop count, then the relay devices at hop l discover relay devices for the hop (l+1) in step 517. The relay devices at lth hop will look for any available relay devices at step 518. If no such devices are available at step 519, return to step 517.

Set device ID to 1 for lth hop at step 520. If the number of devices at lth hop is less than the maximum allowed devices at each hop is checked at step 521. Suppose the number of devices is less than the maximum allowed device number N_{D}. In that case, the device looks for possible relay devices for (l+1)^{th} hop at step 522. Any possible relay devices that are variable or not are checked at step 523. If relay devices are available, select the best relay candidate based on RSRP and SNR at step 525. If any relay candidate relay devices are unavailable at step 523, go to step 526 at step 524. Increment the device counter at step 526. After incrementing the device counter, go to step 521 through step 528. If the number of devices is greater than the allowed devices at step 521, go to step 529, and check whether all the devices are connected for (l+1)^{th} hop; check for devices with unique device id. If all the device ids are unique and the number of devices is less than the maximum number of allowed devices for a hop, i.e. N_{D} go to step 530, and increase the hop count by one. Moreover, go to step 514 via step 531. If all the device ids are not unique at step 529, look for devices with unique ids at step 532. Lebel the relay devices connected through PC-5 links at step 533. Look for the remaining unique devices at step 534. Arrange the left-over discovered devices in descending order at step 535. Lebel the devices appropriately at step 536. Whether or not all connected devices are unique is checked at step 537. If all devices are not unique at step 537, go the step 534 at step 538. If all devices are unique at step 537, increment the hop count by one at step 530 and return to step 514 through step 531.

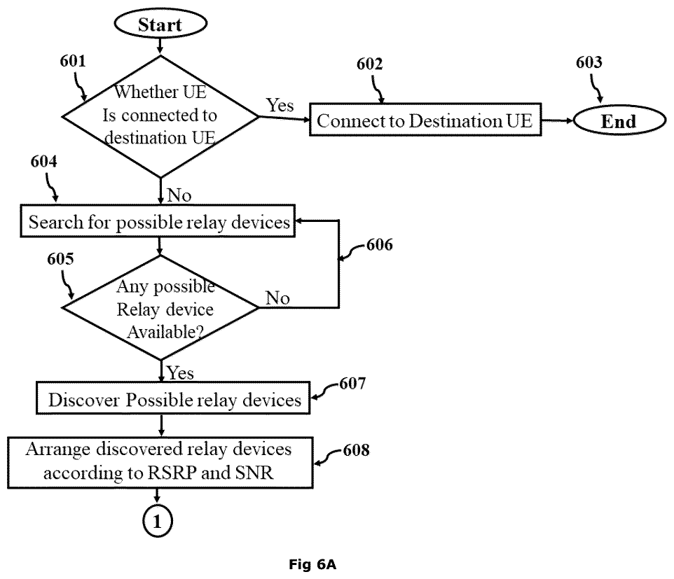

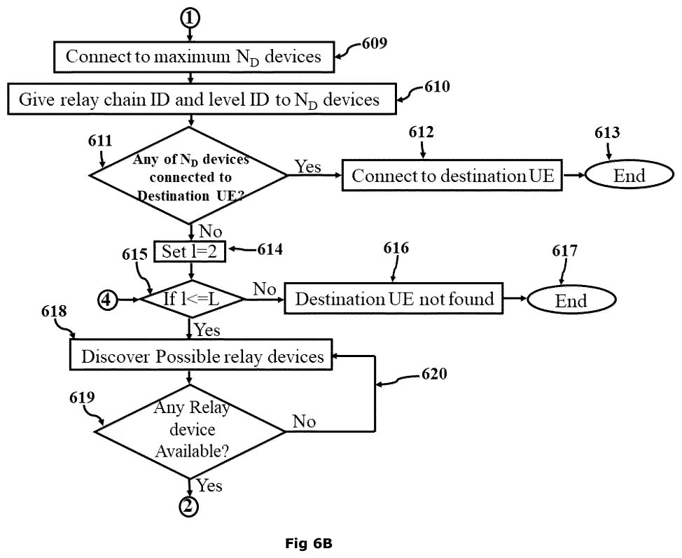

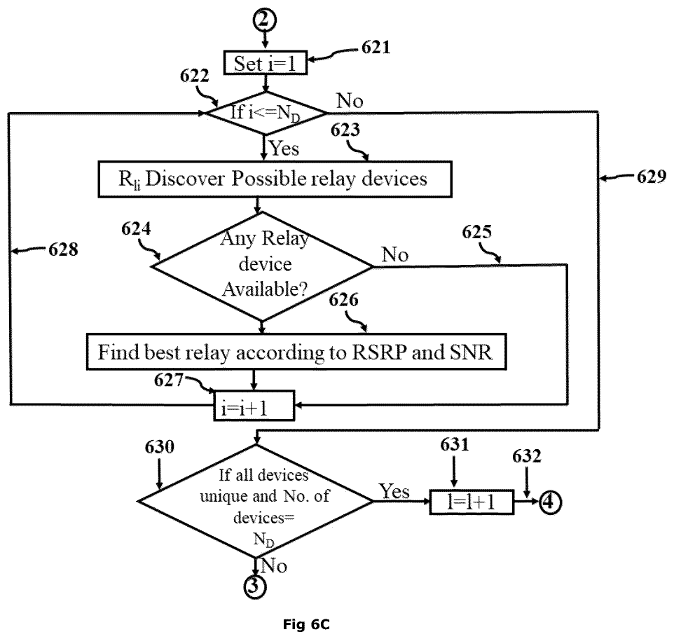

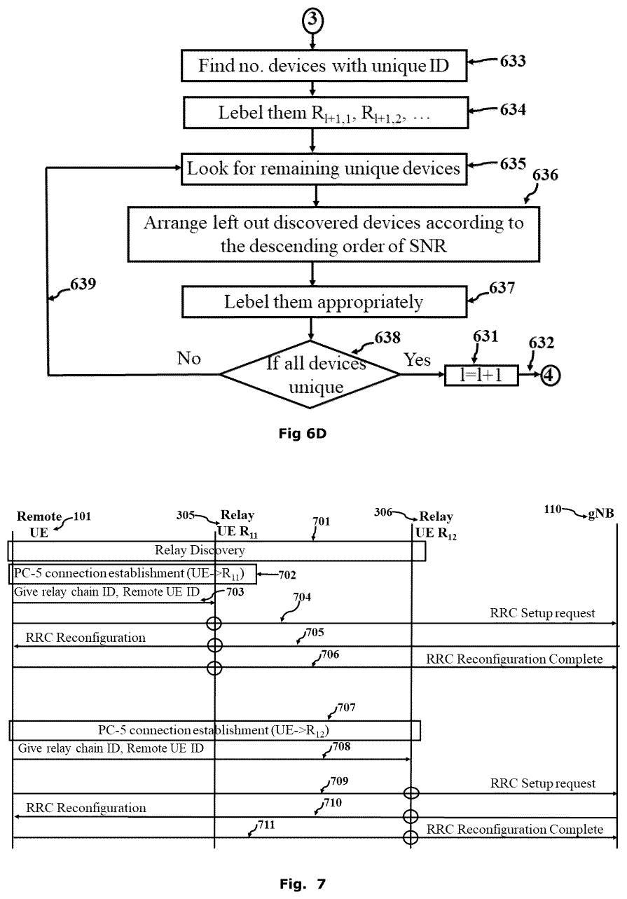

FIG. 6 (6A, 6B, 6C, 6D) shows the steps for establishing a multihop-parallel relay network between a remote UE and a destination UE. The network consists of a maximum of L hops; for each hop, there may be a maximum of N_{D} user equipment (UE) devices. The details of the steps are as follows:

At step 601 it has been checked whether the remote UE is connected to destination UE or not. If the remote UE is connected to destination UE, it will be connected to the corresponding destination UE at step 602, and the process ends there at step 603. However, if the UE is not connected to destination UE, it will search for possible relay devices at step 604. At step 605, the remote UE check whether any possible relay devices are available in the vicinity. If no such devices are available at step 606, it will go to step 604. If possible relay devices are available at step 607; remote UE discovers possible relay candidates using the Prose discovery process. The discovered relay UEs are arranged according to the RSRP and SNR in descending order at step 608. The remote UE will connect the best N_{D} devices through the PC-5 link at step 609. Relay-chain Id and hop Id to the connected N_{D} devices for identifying the relay chain are assigned in step 610. Any of the N_{D} devices connected to the destination UE is checked at step 611. If any devices are connected to the destination UE through the PC-5 link, then remote UE will make a PC-5 connection through that device at step 612.

The procedure ends there at step 613. If no device is connected to destination UE, set the hop count to 2 at step 614. Whether the maximum allowed hop is exceeded or not is taken care of by step 615. If the hop number exceeds the maximum allowed hops, the search for destination UE ends at step 616. The procedure ends at step 617. If the hop count is less than the maximum allowed hop count, then the relay devices at hop l discover relay devices for the hop (l+1) in step 618. The relay devices at l^{th} hop will look for any available relay devices at step 619. If no such devices are available at step 620, return to step 618.

Set device ID to 1 for l^{th} hop at step 621. If the number of devices at lth hop is less than the maximum allowed devices at each hop is checked at step 622. Suppose the number of devices is less than the maximum allowed device number N_{D}. In that case, the device looks for possible relay devices for (l+1)^{th} hop at step 623. Any possible relay devices that are available or not are checked at step 624. If relay devices are available, select the best relay candidate based on RSRP and SNR at step 626. If any relay candidate relay devices are unavailable at step 624, go to step 627 at step 625. Increment the device counter at step 627. After incrementing the device counter, go to step 622 through step 628. If the number of devices is greater than the allowed devices at step 622, go to step 630, via step 629 and check whether all the devices are connected for (l+1)^{th} hop; check for devices with unique device id. If all the device ids are unique and the number of devices is less than the maximum number of allowed devices for a hop, i.e. N_{D} go to step 631, and increase the hop count by one. Moreover, go to step 615 via step 632. If all the device ids are not unique at step 630, look for devices with unique ids at step 633. Lebel the relay devices connected through PC-5 links at step 634. Look for the remaining unique devices at step 635. Arrange the left-over discovered devices in descending order at step 636. Lebel the devices appropriately at step 637. Whether or not all connected devices are unique is checked at step 638. If all devices are not unique at step 638, go the step 635 at step 639. If all devices are unique at step 638, increment the hop count by one at step 631 and return to step 615 through step 632.

FIG. 7 explains L2 U2N remote UE connection establishment procedure for parallel relay scenario. Remote UE is connected to the gNB through dual hop by the relays R11 and R12. The remote UE, 101, discovers the relay at step 701. 101 discovers relay UE-s R11, 305 and R12, 306. A PC-5 connection, 702, is established between 101 and 305. 101 provides relay chain id and its id, 703 to 305. Remote UE, 101 sends RRC setuprequest, 704, through 305 to gNB 110. RRC Reconfiguration message, 705, sent by 110 to 101 via 305. 101 sends RRC Reconfiguration complete, 706, to 110 through 305.

A PC-5 connection, 707, is established between 101 and 306. 101 provides relay chain id and its id, 708 to 306. Remote UE, 101 sends RRC setup request, 709, through 306 to gNB 110. RRC Reconfiguration message, 710, sent by 110 to 101 via 306. 101 sends RRC Reconfiguration complete, 711, to 110 through 306. Between RRC setup request and RRC Reconfiguration the following messages has also been exchanged i.e. RRC Setup, Prepare PC-5 and Uu RLC channel for SRB1, RRC Setup Complete, Security Mode Command, Security Mode Complete. After RRC Reconfiguration Complete PC-5 and Uu RLC channel is prepared for SRB2/DRB.

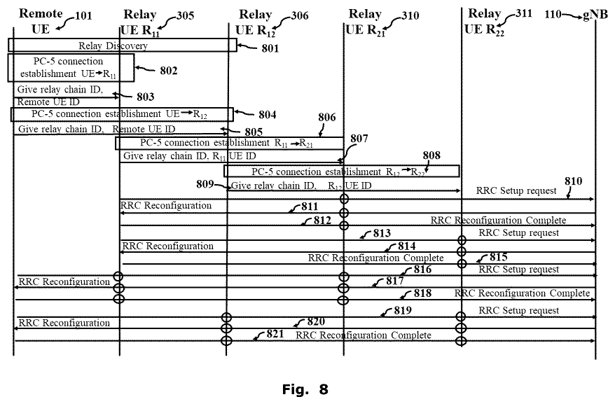

FIG. 8 explains L2 U2N remote UE connection establishment procedure for multihop-parallel relay scenario. Remote UE is connected to the gNB through dual hop by multihop parallel relays R11, R12, R13, and R14. Relays R11, R12 constitutes the hop 1. Hop 2 contains relays R21 and R22. The remote UE, 101, do the relay discovery at 801. 101 discovers relay UE-s R11, 305 and R12, 306. A PC-5 connection, 802, is established between 101 and 305. 101 provides relay chain id and its id, 803 to 305. A PC-5 connection, 804, is established between 101 and 306. 101 provides relay chain id and its id, 805 to 306. In hop 2 305 discovers relay R21, 310. 305 establish a PC-5 link with 310 through 806. Relay chain id and device id are given through 807 to 310. Relay 306 in hop 2 discovers relay R22, 311. 306 establish a PC-5 link with 311 through 808. Relay chain id and device id are given through 809 to 311.

Relay UE, 305 sends RRC setup request, 810, through 310 to gNB 110. RRC Reconfiguration message, 811, sent by 110 to 305 via 310. 305 sends RRC Reconfiguration complete, 812, to 110 through 110. Relay UE, 306 sends RRC setup request, 813, through 311 to gNB 110. RRC Reconfiguration message, 814, sent by 110 to 306 via 311. 306 sends RRC Reconfiguration complete, 815, to 110 through 311. Remote UE, 101 sends RRC setup request, 816, through 305 and 310 to gNB 110. RRC Reconfiguration message, 817, sent by 110 to 101 via 305 and 310. 101 sends RRC Reconfiguration complete, 818, to 110 through 305 and 310. Remote UE, 101 sends RRC setup request, 819, through 306 and 311 to gNB 110. RRC Reconfiguration message, 820, sent by 110 to 101 via 306 and 311. 101 sends RRC Reconfiguration complete, 821, to 110 through 306 and 311. Between RRC setup request and RRC Reconfiguration the following messages has also been exchanged i.e. RRC Setup, Prepare PC-5 and UuRLC channel for SRB1, RRC Setup Complete, Security Mode Command, Security Mode Complete. After RRC Reconfiguration Complete PC-5 and Uu RLC channel is prepared for SRB2/DRB.

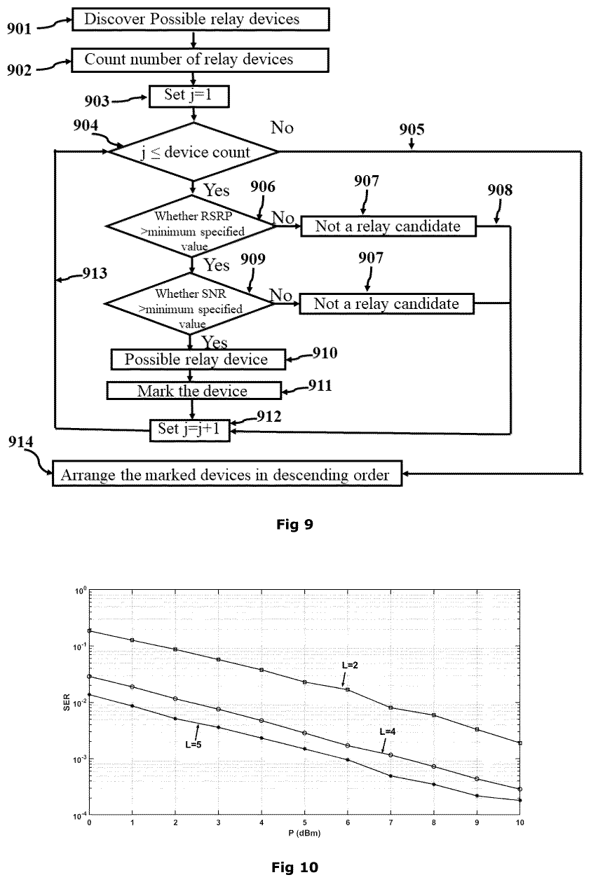

A relay ranking algorithm has also been suggested in FIG. 9. The relay ranking algorithm is used in the steps 507, 525, 535, 608, 626, and 636. At step 901, a remote or relay UE discovers possible relay devices. The discovered relay devices are counted in step 902. The device counter is set to one at step 903. Whether the device count is less than the number of discovered devices is checked in step 904. If the device count is less than the total discovered devices, the RSRP of the particular device is better than the minimum specified level and is checked at step 906. If RSRP is not greater than the minimum specified value, the device is not a relay candidate, and this decision is taken at step 907 and goes to step 912 through 908. If the RSRP of the device is greater than the minimum specified value, the SNR of the device is checked at step 909. If SNR is less than the specified value, go to step 912 through steps 907 and 908. If SNR exceeds the specified value, the device is a potential candidate for relay device at step 910. At step 911, the device is marked. The device counter is incremented by one at step 912. At step 913, the procedure is returned to step 904. If step 904 is not successful, go to step 914 through step 905. At step 914, the marked devices are arranged in descending order.

FIG. 10 shows the relationship between SER of the parallel-multihop relay combination system and transmit power of UEs, i.e P. It can be observed that if P is increased the average SER performance of the overall system improves due to improvement of received SNR at each UE. Moreover, it can be found that if the number of hops, i.e. L is increased the SER performance also improves. This occurs due to the fact that if L is increased, the distances between intermediate hops reduces, therefore the pathloss reduces, hence the received SNR at each UE gets improved. This leads to the improvement of average SER performance of the given system.

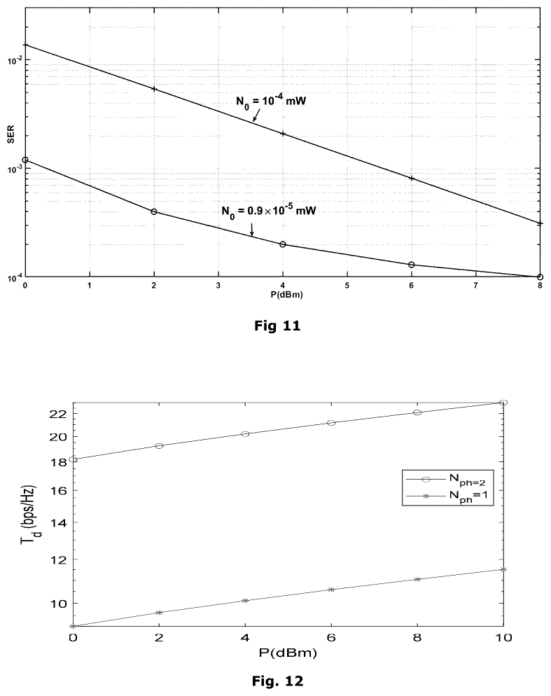

FIG. 11 flashes on the relationship between SER of the parallel-multihop relay combination system and noise power, i.e., N₀. It can be observed that if N₀ is reduced, SER performance improves due to the SNR improvement at each UE.

FIG. 12 depicts the relationship between overall throughput (T_{d}) of the parallel-multihop relay communication system and transmit power of a UE, i.e., P for different number of relays. It can be observed that if P is increased, the overall throughput performance improves due to the SNR improvement at each UE. Moreover, if the number of parallel relays per hop (Nₚₕ) is increased from one to two, the throughput of the overall system improves. The reason behind this is, if Nₚₕ is increased, the more data symbols can be transmitted to the remote UE by gNB through the relay paths simultaneously.

### Exemplary Embodiments

Simulation parameters are used to obtain the results are given below:

TABLE 1
Key simulation parameters

| Simulation parameter | Value |
|---|---|
| N_{D} (number of parallel relays per hop) | 2 |
| N_{c} (cyclic prefix length) | 7 |
| α (Pathloss exponent) | 4 |
| Nₛ (number of sub-carriers) | 256 |
| d_{gu} (distance between gNB and remote UE) | 24 m |

1. A multi-hop parallel relay based networking system for connecting a source remote UE (user equipment) with a destination UE or next Generation NodeB (gNB) comprises
multiple parallel relay devices in multiple connected hops between the source remote UE and the destination UE or gNB;
Uu link for connecting the destination UE or gNB with last hop of the multiple connected hops;
PC-5 link for connecting the source remote UE with first hop of the multiple connected hops.

2. The system as claimed in claim 1, wherein the Uu link includes air interface between NR-UE (New Radio User equipment) and a gNB (next generation Node B).

3. The system as claimed in claim 1, wherein the PC-5 link includes direct communication interface between a UE (user equipment) to another UE (user equipment).

4. The system as claimed in claim 1, wherein each of the hops includes one or more relay devices and each of the hops is connected to its neighboring hops through the said PC-5 links, whereby the relay devices in a particular hop are connected to one or more relay devices from preceding hop through separate radio links.

5. A method of establishing RRC (radio resource control)-level connection and relay selection for multihop-parallel relay topology in 5G NR comprising
arranging discovered relay devices according to RSRP and SNR;
searching and discovering of possible relay device;
checking of all relay devices for unique ID;
checking for number of the relay devices with unique ID, labelling them and checking whether all the said relay device received unique ID.

6. The method as claimed in claim 5 wherein arranging discovered relay devices according to RSRP and SNR comprises
checking the destination UE whether the said UE is in an outage or is a remote node;
connecting the UE to the corresponding gNB if the UE is not a remote node or not in the outage;
searching for possible relay devices if the UE is remote or in an outage;
checking for any possible relay devices, if it is found, it will discover the possible relay device and if it is not found it will again search for possible relay devices;
arranging the said discovered relay devices according to RSRP and SNR in descending orders.

7. The method as claimed in claim 5, wherein searching and discovering of possible relay device comprises
connecting the maximum N_{D} devices through the PC-5 links;
assigning the relay chain ID and hop ID to N_{D} devices;
checking whether any of N_{D} devices connected to gNB;
ending process if it is found connecting to gNB through RRC connection alternatively setting the hop count to 2 and checking the hop number whether the maximum allowed hop is exceeded or not;
whereby after finishing the search for gNB if the hop count is less than the maximum allowed hop count, then the relay devices at hop l discover relay devices for the hop (l+1) and the relay devices at lth hop will look for any available relay devices and if no such devices are available, again discovering for possible relay devices.

8. The method as claimed in claim 5, wherein checking of all relay devices for unique ID comprises
setting device ID to 1 for lth hop;
checking the number of devices at lth hop is less than the maximum allowed devices at each hop;
whereby if the number of devices is less than the maximum allowed device number N_{D}, the device looks for possible relay devices for (l+1)^{th} hop including checking for any possible relay devices that are variable or not;
whereby if the relay devices are available, selecting the best relay device based on RSRP and SNR alternatively if any relay candidate in relay devices are unavailable incrementing the device counter and after incrementing the device counter, checking the number of the said relay devices at lth hop is less than the maximum allowed devices at each hop;
whereby if the number of the relay devices is greater than the allowed relay devices checking whether all the relay devices are connected for (l+1)^{th} hop including checking for the relay devices with unique device ID;
whereby if all the device IDs are unique and the number of devices is less than the maximum number of allowed devices for a hop, i.e., N_{D} increasing the hop count by one and again checking the hop number Whether the maximum allowed hop is exceeded or not.

9. The method as claimed in claim 5, wherein checking for number of relay devices with unique ID, labelling them and checking whether all the said relay device received unique ID comprises
looking for devices with unique IDs, if all the device IDs are not unique;
labeling the relay devices connected through PC-5 links;
looking for the remaining unique devices and arranging the remaining discovered devices in descending order;
labeling all the devices appropriately. and checking for all connected devices are unique or not;
looking for the remaining unique devices, if all devices are not unique and incrementing the hop count by one and return to the step wherein checking the hop number, whether the maximum allowed hop is exceeded or not if all devices are unique.
